(19) United States
(12) Patent Application Publication
(10) Pub. No.: US 2013/0035982 A1
(43) Pub. Date: Feb. 7, 2013

(54) METHOD AND SYSTEM FOR CREATING TARGETED ADVERTISING UTILIZING SOCIAL MEDIA ACTIVITY

(71) Applicants: Jun Zhang, Hamden, CT (US); Yuling Wu, Scarsdale, NY (US); Hongping Liang, Woodbridge, CT (US); Qiuju Gu, Trumbull, CT (US); Alexandra Mack, Monroe, CT (US); Alla Tsipenyuk, Woodbridge, CT (US)

(72) Inventors: Jun Zhang, Hamden, CT (US); Yuling Wu, Scarsdale, NY (US); Hongping Liang, Woodbridge, CT (US); Qiuju Gu, Trumbull, CT (US); Alexandra Mack, Monroe, CT (US); Alla Tsipenyuk, Woodbridge, CT (US)

(73) Assignee: Pitney Bowes Inc., Stamford, CT (US)

(21) Appl. No.: 13/368,515

(22) Filed: Feb. 8, 2012

Related U.S. Application Data
(60) Provisional application No. 61/515,032, filed on Aug. 4, 2011.

(51) Int. Cl. G06Q 10/00; G06Q 30/02

(52) U.S. Cl. 705/7.29

(57) ABSTRACT

Methods and systems for identifying, retrieving and analyzing social media data pertinent to a business' customers to derive personal information that can be used for targeted advertising, thereby helping the business improve and grow. A scanning engine searches social media spaces to identify the presence of a business' customers. A data engine will collect the social activity data from the various social networking sites based upon social presence identified by the scanning engine. An analytic engine will analyze the information collected by the data engine. This will give a business a 360 degree view of its business and customers and help the business to find the cause behind the effect and develop the right strategy to improve and grow its business.

### CROSS REFERENCE TO RELATED APPLICATIONS

This application claims the benefit of U.S. Provisional Application Ser. No. 61/515,032, filed Aug. 4, 2011, the specification of which is hereby incorporated by reference.

### FIELD OF THE INVENTION

The invention disclosed herein relates generally to targeted advertising systems, and more particularly to a method and system that utilizes a customer's social media activities to enable a business to better communicate with its customers to provide the right message, at the right time, and through the right channel.

### BACKGROUND OF THE INVENTION

In today's highly competitive business world, advertising to customers, both potential and previous, is a necessity. Businesses are always looking for ways to increase revenue, and increasing its sales to customers through advertising plays a large part in many business's plans for growth. Advertising has shown to be an effective method to inform, persuade or remind target buyers of the business' goods, services or goodwill, with the ultimate goal being that an advertisement will result in the sale of the goods or services. Studies have confirmed that the more that an advertisement can be customized for a particular intended recipient, for example to include some personal information relating to the recipient, the more likely that it is to be successful. Such customized advertisements, however, require knowledge of some personal information of the intended recipient, which many businesses may not possess.

### SUMMARY OF THE INVENTION

The present invention alleviates the problems described above and provides a powerful data and analytical platform which can identify, retrieve and analyze social media data pertinent to a business' customers to derive personal information that can be used for targeted advertising, thereby helping the business improve and grow. A scanning engine is provided that can search a wide range of social media spaces, including, for example and without limitation, FaceBook, Twitter, Yelp, LinkedIn, YouTube, Flickr, Blog, etc. to identify the presence of a business' customers (either other businesses or consumers) using information such as the customer's name, address, web site, email, business keywords or other identifiable information. The scanning engine will use the most suitable scanning techniques for the customer based upon known information. For example, if the customer is another business, the scanning engine can scan by name, address, email or other relevant business keywords. If the customer is a consumer, the scanning engine can scan by name or email address. The scanning engine runs as cron jobs, which can run as scheduled or on demand. The scanning engine can be configured, managed and monitored from both command line and an administration console (a central administration interface to configure, manage and monitor components of the platform). The scanning process can be configured to run in multiple instances and run on multiple nodes to improve performance and scalability for large scanning.

A data engine will collect the social activity data from the various social networking sites based upon social presence identified by the scanning engine. The data engine will use appropriate data acquisition techniques to retrieve social media data from the various social media sites, including, for example, the social media sites Application Programming Interfaces (API), such as Facebook Graph API, Twitter API, Yelp API etc, and scraping. The scraping technique will be used when APIs are not adequate to acquire enough data. In the case of multiple scanning results returned for a given entity, a matching process will be used to filter scanning results by known entity information. The data engine also has a data normalization process to merge and normalize social media data from various sources for an analytics engine. The data engine is designed as CRON jobs which can run as scheduled or on demand. The data engine process can be configured, managed and monitored from both command line and administration console.

An analytic engine will analyze the information collected by the data engine utilizing, for example, social dashboards (an overview of a business' customers' social media presence), topic identification, sentiment analysis, and social network graphical analysis. This will give a business a 360 degree view of its business and customers and help the business to find the cause behind the effect and develop the right strategy to improve and grow its business. The present invention can provide various reporting functionalities for different scenarios. For example, for marketing, the present invention can provide an overview of a business's customers' social presence, social connections, social activity level and topics/interests/social triggers etc. to help the business design different marketing strategies to target its online customers. It can also provide extra social data to help the business to augment its customer profiling capabilities. For brand monitoring, the present invention can provide a business with an overview of its social image/reputation by collecting, merging and analyzing reviews/comments/data from various social media sources. It can also give the business a detailed social media competitor analysis. The present invention leverages rich information generated by consumers on various social networking sites to provide a new source of customer insight and combines social media data, location intelligence and business transaction data to create a unique business insight and trigger actionable recommendations.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like of corresponding parts.

FIG. 1 illustrates a block diagram of a system according to an embodiment of the present invention.

FIG. 2 illustrates in block diagram form a high level architecture of the technical platform of the present invention.

FIG. 3 illustrates an example of a report that can be generated utilizing the present invention.

FIG. 4 illustrates an example of recommendations that can be provided based on the report of FIG. 3 according to an embodiment of the invention.

FIG. 5 illustrates in flow diagram form the processing performed according to an embodiment of the present invention.

FIG. 6 illustrates in flow diagram form an example of the analytic processing performed according to an embodiment of the present invention.

### DETAILED DESCRIPTION OF THE PRESENT INVENTION

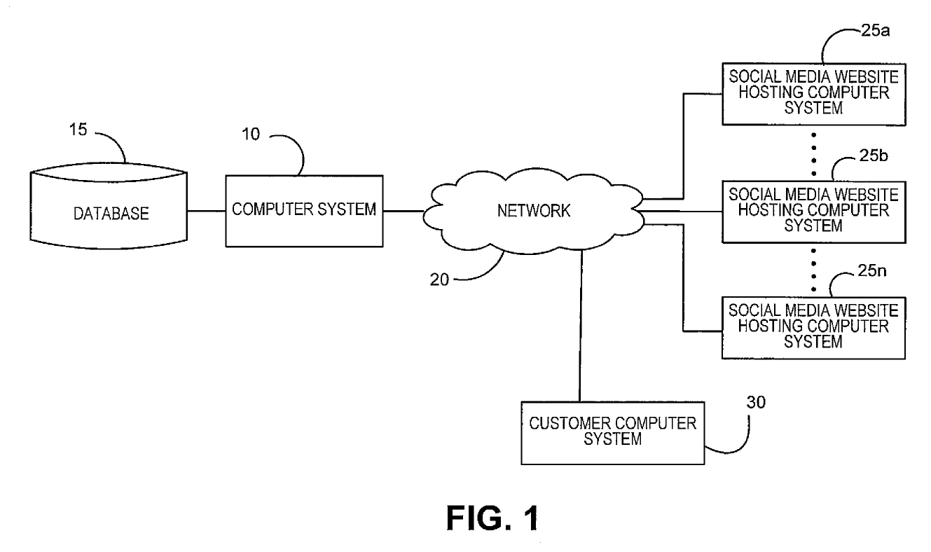

In describing the present invention, reference is made to the drawings, wherein there is seen in FIG. 1 a block diagram of a system according to an embodiment of the present invention. As illustrated in FIG. 1, a computer system 10 is in electronic communication with a network 20, which may be, for example, the Internet, one or more private computer networks, or any combination thereof. The computer system 10 is also in electronic communication with a database 15. Database 15 stores information including, for example and without limitation, social media information obtained as described below. One or more social media website hosting computer systems (25a, 25b . . . 25n), are coupled to the network 20. Each hosting computer system can host one or more social media websites. Additionally, a customer computer system 30, which may be, for example, a personal computer or the like, is coupled to the network 30 and allows customers to access and use social media websites hosted by the computer systems 25a-25n. It should be understood that the number of social media website hosting computer systems 25 and customer computer systems 30 are not limited in number, and any number can be connected to the network 20.

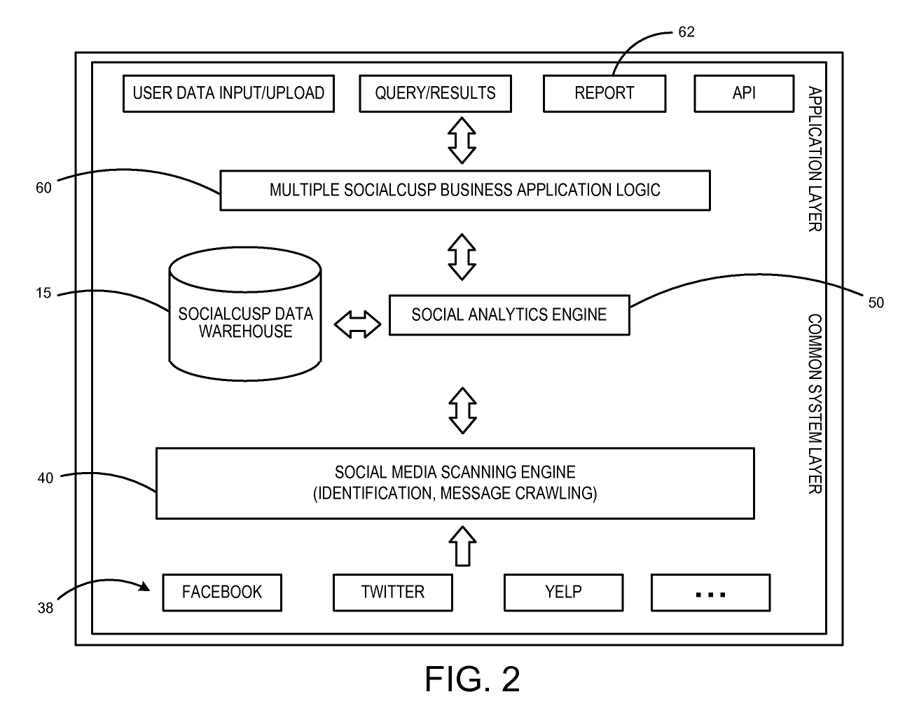

FIG. 2 illustrates in block diagram form a high level architecture of the technical platform of the present invention. The present invention includes various software engines/processes that can be executed by the computer system 10. As shown in FIG. 2, the present invention is designed to support a wide range of social media data sources 38, including, for example and without limitation, FaceBook, Twitter, Yelp, LinkedIn, YouTube, Flickr, Blog, etc. A social media scanning engine 40, which is preferably a standalone java application, is configured to crawl through the social media data sources 38 to collect social media data. The scanning engine 40 performs an identification process by taking inputs such as a list of business or consumer names, addresses, e-mail addresses, etc. and crawling through the social media sites to identify the presence of a business's customers (either other businesses or consumers). The scanning engine 40 can use the most suitable scanning techniques using business filters to further filter the results based upon other known information about a given business or consumer. For example, for business scanning, it can scan by name, address, email or other relevant business keywords. For consumer scanning, it can scan by name or e-mail address. A data collection process collects the social activity data identified by the scanning engine using appropriate data acquisition techniques to retrieve social media data from the various social media sties, including, for example, the social media sites' APIs and/or screen scraping techniques. A data normalization process can be performed to merge and normalize the social media data from the various sources. The collected data can be stored in the database 15. Preferably, the data is time stamped for each identification attempt and the result.

After data has been collected, a social analytics engine 50 will conduct various analyses using the information gathered from the various social media sites to create effective social measurements that measure a business's and the business's customers' social participation and activity level. An accurate and easy to use social participation and activity level measurement is a very important tool that can enable a small business to strategize, act, and monitor their use of social media for business purposes. The present invention provides a plurality of indices to measure social media related activities or characteristics of small businesses, including (i) a measure of the business's social presence activity level, (ii) a measure of the business's customers' social media adoption level, and (iii) a measure of a business's social reputation, as described below.

The social presence activity level score measures a business's engagement level on a social media site, such as a Facebook fan page or Twitter account. There are multiple levels of information regarding consumers' engagement level at a business's social media site, including Reachability (R): number of total fans or followers, Interactivity (I): active fans (total number of fans who post at least one message); and Activity (A): Average number of consumers who post a message on the site every week. Each of these variables is utilized to calculate a business's social presence (SP) score on a particular social media site according to the following equation:

(SP)=R*(1+a*(I/R))+b*(A/R)) Equation (1)

Note that a and b are tunable parameters, and can be adjusted accordingly depending on the objective of the business. For example, if engaging actively with customers is the most important objective of the business, then a really high value of “a” and “b” can be set. There are two benefits of creating this one score measurement: first, most viral effect of social media marketing only work well when the consumers actively post or respond to the business's marketing message. Thus, an active individual should have a much higher value than an inactive one. Equation (1) allows a business to adjust these parameters based upon business objectives. Secondly, a well-defined single score measurement will make any following measurement and statistical analysis tasks much easier to study how a business uses social media sites, especially when there are needs to compare multiple businesses, or compare a business's performance with its competitors or industry verticals. Note that this score (SP) is a measurement for a single social media site. The scores for multiple social media sites can be further combined to calculate one score for a business given all presence of a business on social media sites is available by summing all of the individual scores for each site.

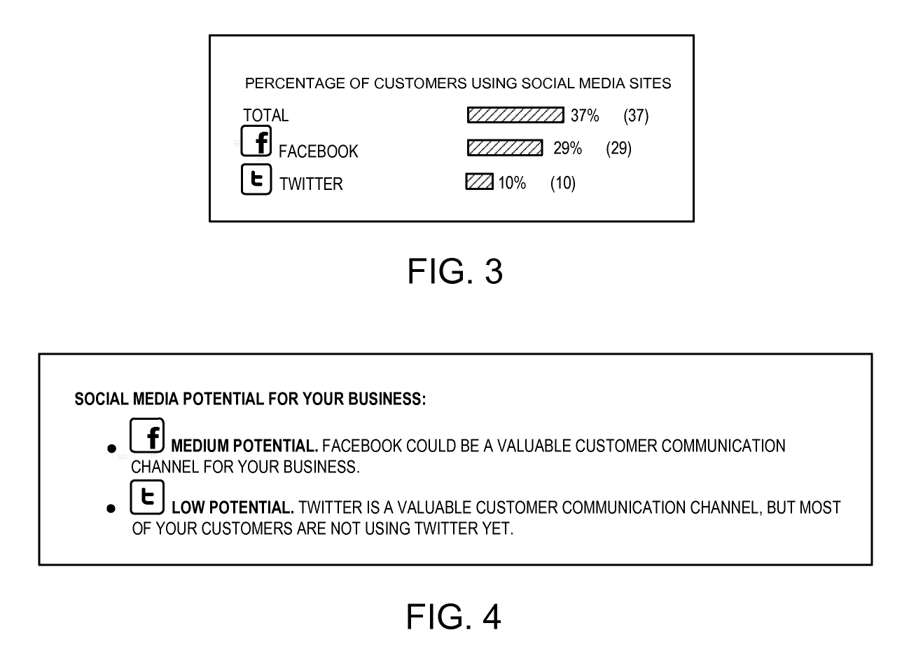

The business's customers' social media adoption level provides an indication to a business as to how much its customers use social media sites. An important factor in deciding how much effort a business should put on social media is whether their customers are using these social media sites. The present invention can determine how much a business's customers have been using social media sites, thus giving business owners directions on whether social media is a good channel for them to communicate with their customers. FIG. 3 illustrates an example of such report for a business, and FIG. 4 illustrates related recommendations based on the scanning result. As can be seen from FIG. 3, a total of 37% of a business's customers use a social media site, while 29% of its customers utilize Facebook, and 10% utilize Twitter (the total percentage reflects an overlap of customers that may use both sites). Thus, as shown in FIG. 4, since a large portion of the business's customers utilize Facebook, the analytics engine can recommend using Facebook as a communication channel with its customers. Similarly, since few customers were identified by the scanning engine 40 as using twitter, this social media site currently might not be a good way for the business to communicate with its customers.

The business's social reputation measurement provides an indication of how the business is perceived by its customers based on discussions about the business on social media sites. There are multiple sources of a business's reputation on the Internet, such as different review sites like Yelp, people's mentions in tweets, or discussions in online forums. There are mainly two perspectives related to a business's reputation: number of people talking about the business and the overall sentiment of the discussions about the business. The scanning engine 40 will identify relevant instances where the business is mentioned, and can provide each of those instances for use by the business. The analytics engine 50 can build a white list of relevant social media sites to improve the search accuracy, and use sentiment analysis techniques to analyze the content of relevant discussions about the business and calculate an overall sentiment reputation of the business.

A business application logic layer 60 provides several processes that allows the user to review the data collected and analyzed by the scanning engine 40 and analytical engine 50. Logic layer 60 can generate reports 62 that will give a user an overview of the user's customers' social media presence. FIG. 3 illustrates an example of such a report. For example, the total number of the user's customers that are active on social networks can be provided, with a breakdown of the number in each different social network site provided. The report can also include the customers' activity level by social media site, as well as the number of social connections, e.g., fans or friends, that the user's customers have. A social profiling process can provide the user with information about each customer, which can include, for example, the customer name, address, e-mail address, etc., the number of social media network sites on which the specific customer has an account, the status of social connections maintained by that specific customer, the amount of activity on each of the social media sites, and the topics or interests discussed by that customer on each of the social media sites.

Business application logic layer 60 can also be used to analyze text from a business's or customer's social media sites/activity. By analyzing the text of social media activity, e.g., the text of posts made by a customer on a social media site, the logic layer 60 can determine the topics of the posts, and perform a sentiment analysis to determine the customer's sentiment about a specific topic. Thus, the present invention can identify a list of topics in which a business or individual is interested in, as well as their attitude toward that topic. This will allow a business to utilize such information to generate marketing material based on the customers' activities. For example, using the information provided by the present invention, an e-mail campaign list that utilizes a social filter to identify customers whose social media site activity meets specified requirements can be generated. For example, filtering could be performed using social media site participation, customer location, topics discussed, amount of activity, interactivity (e.g., number of fans, followers, friends, etc.).

In addition, there are some special topic analyses that can be more valuable than others in the business context. By detecting an event announced in a social media site by a business or individual customer, it is possible to determine that an upcoming event can be used as a good communication point. For example, if the user is a travel agent, and the business application logic layer 60 identifies a customer that posted on a social media site that he will soon be taking a vacation, the travel agent business can send the customer communications about current travel promotions and deals being offered by the travel agent. Event detection of a competitor using the competitor's social media activity can also provide a valuable tool for a business to keep updated with its competitors' activities and promotions.

The business application logic layer 60 further includes a social brand monitoring process, which can utilize the business's social reputation measurement, that provides a business with insight with respect to its reputation and brand based on discussion in which the business is mentioned. For example, the social brand monitoring process can provide the number of times a user business is mentioned in social media sites, the details about the specific sites, time of discussion, and details by sentiment, e.g., either positive, negative, or neutral mentions. Thus, a business can find out what its customers are saying about the business, both positive and negative, on social media sites. This will give a business a full 360 degree view of its business, allowing it to address any issues that customers may have that would not have otherwise been known to the business. Similarly, a competitor analysis process within the business application logic layer 60 can be used to provide a comparison of a business with its competition's social brand presence. This can provide a business with insight as to what its customers like/dislike about both the business and its competitors, and allow the business to take actions to address customer issues and ensure continued customer loyalty.

The business application logic layer 60 can also determine the online social influence and/or reachability of a business or individual. Once an individual or business social presence is identified on social media sites, such as, for example, Facebook and Twitter, the logic layer 60 can retrieve information related to an individual or business's social influence (i.e. number of Twitter followers and Facebook friends), and identify high social influencers based their social influence score. Based on the number of follower/friends of an individual, the number of posts made by the individual, and the topic of the posts, it can be determined if a particular individual may be a highly influential customer for the business.

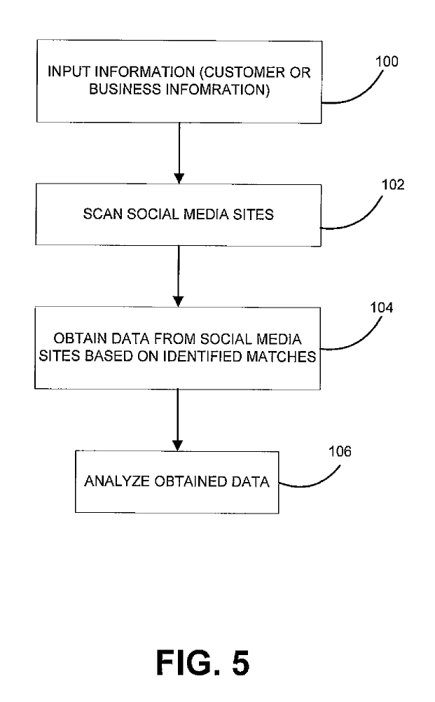

Referring now to FIG. 5, there is illustrated in flow diagram form the processing performed by the computer system 10 according to an embodiment of the present invention. In step 100, a user will provide the computer system 10 with information related to its customers (either other businesses or individual consumers) or its business. This can be provided, for example, by the user using a customer computer system 30 to provide information to the computer system 10. Such information could include, for example, a list of customer names, addresses, web sites, email addresses, business keywords or other identifiable information. In step 102, the scanning engine 40, which preferably is executed by the computer system 10, scans the various social media sites to identify any matches with the information received in step 100. In step 104, the scanning engine 40 obtains data from the social media sites based on the matches identified in step 102. Such data can be stored in the data warehouse 15. In step 106, the analytics engine 50 analyzes the data obtained in step 104 to provide useful information to the user concerning various aspects of the social media sites. Such information can include, for example, the plurality of indices to measure social media related activities or characteristics of small businesses as previously described.

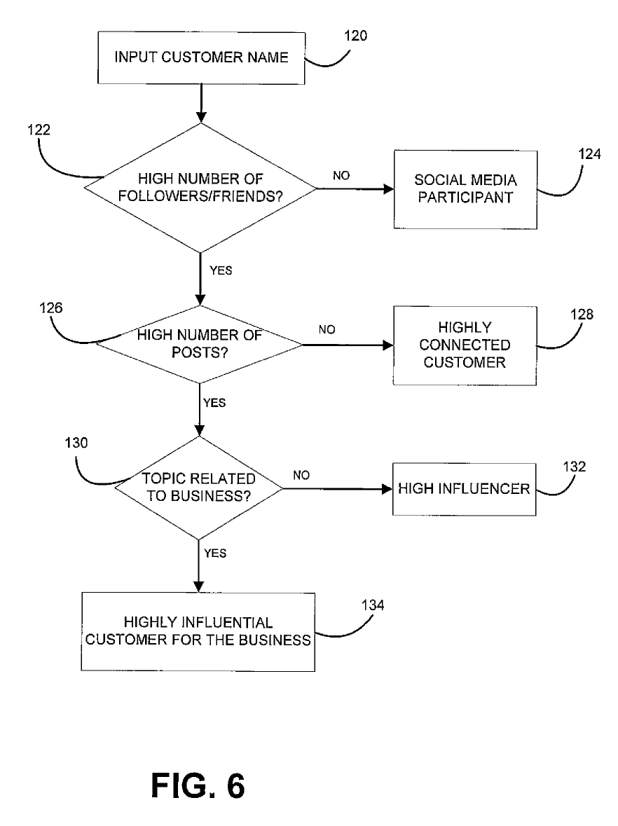

FIG. 6 illustrates in flow diagram form an example of the analyzing that can be performed in step 106 of FIG. 5, and more particularly, how the business application logic layer 60 can determine the online social influence of an individual. As illustrated in FIG. 6, in step 120 a customer name whose online social influence is desired to be determined is input to the computer system 10. In step 122, the business application logic layer 60 determines if the customer has a high number of friends/followers on social media sites. If a customer does not have a high number of friends/followers, then instep 124 the customer is determined to be a social media participant. If the customer does have a high number of friends/followers, then in step 126 logic layer 60 determines if the customer has generates a high number of posts to the social media sites. If the customer does not generate a high number of posts, then in step 128 the customer is determined to be a highly connected customer. If the customer does generate a high number of posts, then in step 130 the logic layer determines the extent to which the topic of the customer's posts relate to the business, e.g., either directly mention the business by name or relate to the domain of the business. If the topics of the customer's posts do not match the business's domain, then in step 132 the customer is deemed to be a high influencer, due to the large number of friends/followers and large number of posts. If the topics of the customer's posts do match the business's domain (or exceed some predetermined threshold value), then in step 134 the customer is deemed to be a highly influential customer for the business, due to the large number of followers/friends, the large number of posts issued by the customer, and the large number of such posts that relate to the business. Based on this information, a business can identify those customers that can help to advertise the business and that should be recipients of special promotions, advertisements, etc.

Thus, the present invention builds various business applications based upon its analytical functions. For instance, by combining a business's customer social adoption rate and their social media engagement measures, the present invention will be able to recommend whether the business can spend more or less resources on social media customer communications. By combining reputation management, social media engagement measures, and events detection, the present invention can help a business to compare its social media use and its social reputation with its customers, and adjust its business process accordingly.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a business to determine customer social media activity, the method comprising:
receiving, by a processing device, information related to at least one customer of the business;
scanning, by the processing device, at least one social media site to identify matches with the received information;
collecting, by the processing device, data based on the identified matches;
analyzing, by the processing device, the collected data to determine the at least one customer's participation in the at least one social media site; and
providing, by the processing device, a report indicating the at least one customer's participation in the at least one social media site.

2. The method of claim 1, wherein analyzing the collected data further comprises:
identifying topics that are of interest to the at least customer based on posts made by the at least one customer to the at least one social media site.

3. The method of claim 1, wherein analyzing the collected data further comprises:
detecting an upcoming event announced on the at least one social media site by a respective customer of the at least one customer.

4. The method of claim 3, further comprising:
creating an advertisement for the respective customer based on the upcoming event.

5. The method of claim 1, wherein analyzing the collected data further comprises:
determining an activity level for a respective customer of the at least one customer on the at least one social media site.

6. The method of claim 5, wherein determining an activity level for the respective customer includes determining a number of friends/followers for the respective customer on the at least one social media site.

7. The method of claim 5, wherein determining an activity level for the respective customer includes determining a number of posts made by the respective customer on the at least one social media site.

8. The method of claim 7, further comprising:
determining, by the processing device, an amount of posts made by the respective customer on the at least one social media site that relate to the business.

9. The method of claim 1, wherein the at least one social media site comprises a plurality of social media sites, and analyzing the collected data further comprises:
determining whether the at least one customer participates in each of the plurality of social media sites.

10. The method of claim 9, further comprising:
providing, by the processing device, a recommendation as to which of the plurality of social media sites the business should use for communicating with the at least one customer based on participation of the at least one customer in the plurality of social media sites.

11. The method of claim 1, wherein the information related to the at least one customer includes at least one of a name, an address, and an e-mail address.

12. A method to determine a business's reputation among customers that utilize social media, the method comprising:
receiving, by a processing device, information related to the business;
scanning, by the processing device, at least one social media site to identify matches with the received information;
collecting, by the processing device, data based on the identified matches;
analyzing, by the processing device, the collected data to determine a number of times the business is mentioned in the at least one social media site; and
providing, by the processing device, a report indicating the number of times the business is mentioned in the at least one social media site.

13. The method of claim 12, wherein analyzing the collected data further comprises:
determining a sentiment toward the business for discussions in which the business is mentioned in the at least one social media site.

14. A system for determining social media activity of a business's customer, the system comprising:
a processing device coupled to a network, the processing device being programmed to receive information related to at least one customer of the business; scan at least one social media site via the network to identify matches with the received information; collect data based on the identified matches; analyze the collected data to determine the at least one customer's participation in the at least one social media site; and provide a report indicating the at least one customer's participation in the at least one social media site.

15. The system of claim 14, wherein the processing device is further programmed to identify topics that are of interest to the at least customer based on posts made by the at least one customer to the at least one social media site.

16. The system claim 14, wherein the processing device is further programmed to detect an upcoming event announced on the at least one social media site by a respective customer of the at least one customer.

17. The system of claim 16, wherein the processing device is further programmed to create an advertisement for the respective customer based on the upcoming event.

18. The system of claim 14, wherein the processing device is further programmed to determine an activity level for a respective customer of the at least one customer on the at least one social media site.

19. The method of claim 5, wherein determining an activity level for the respective customer includes determining a number of friends/followers for the respective customer on the at least one social media site.

20. The system of claim 14, wherein the processing device is further programmed to determine a number of posts made by the respective customer on the at least one social media site.

21. The system of claim 14, wherein the processing device is further programmed to determine an amount of posts made by the respective customer on the at least one social media site that relate to the business.

22. The system of claim 14, wherein the at least one social media site comprises a plurality of social media sites, and the processing device is further programmed to determine whether the at least one customer participates in each of the plurality of social media sites.

23. The system of claim 22, wherein the processing device is further programmed to provide a recommendation as to which of the plurality of social media sites the business should use for communicating with the at least one customer based on participation of the at least one customer in the plurality of social media sites.

24. The system of claim 14, wherein the information related to the at least one customer includes at least one of a name, an address, and an e-mail address.

25. The system of claim 14, wherein the processing device is further programmed to determine a number of times the business is mentioned in the at least one social media site and provide a report indicating the number of times the business is mentioned in the at least one social media site.

26. The system of claim 25, wherein the processing device is further programmed to determine a sentiment toward the business for discussions in which the business is mentioned in the at least one social media site.
